(19) United States
(12) Patent Application Publication
(10) Pub. No.: US 2008/0205254 A1
(43) Pub. Date: Aug. 28, 2008

(54) Content Protection on a Record Carrier

(75) Inventors: Johan Cornelis Talstra, Eindhoven (NL); Antonius Adriaan Maria Staring, Eindhoven (NL); Paulus Gijsbertus Petrus Weijenbergh, Eindhoven (NL); Jakob Gerrit Nijboer, Eindhoven (NL); Maurice Jerome Justin Jean-Baptiste Maes, Eindhoven (NL); Johannes Hendrikus Maria Spruit, Eindhoven (NL); Johannes Josephus Leonardus Maria Van Vlerken, Eindhoven (NL); Robert Albertus Brondijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/581,119

(22) PCT Filed: Nov. 25, 2004
(86) PCT No.: PCT/IB2004/052549

§ 371 Date: May 30, 2006

(30) Foreign Application Priority Data
Dec. 2, 2003 (EP) 03104497.7
May 19, 2004 (EP) 04102208.8

(51) Int. Cl. G11B 7/24; G11B 20/00; G11B 7/007; G11B 27/32

(52) U.S. Cl. 369/275.3

(57) ABSTRACT

The invention relates to a record carrier having a data zone (7) and an initial zone (25) and comprising a main channel storing content and a side channel storing address information and data relevant for making recordings. It further relates to methods and devices for protecting content stored on a record carrier and for reading out protected content. To provide a record carrier with content protection information (20, 22, 24, 26, 28) stored on it, which can be used with legacy devices without causing confusion, which can substantially be produced without extra production steps and which can be easily read by common devices, it is proposed to store said content protection information (20, 22, 26, 28) for protection of said content in said side channel in said data zone (7).

The invention relates to a record carrier having a data zone and an initial zone and comprising a main channel storing content and a side channel storing address information and data relevant for making recordings. It further relates to methods and devices for protecting content stored on a record carrier and for reading out protected content. The invention also relates to a method to distribute a key block through blank recordable media for use in copy protection systems based on such a key block, a record carrier comprising such a key block, an apparatus for reading out such a record carrier and a copy protection system employing such a key block.

Modern systems for protecting content which may be copied onto recordable media, but only so under certain strict conditions e.g. copy once material, or broadcast content protected by the so called broadcast flag, are almost all based on a so called key block (KB). Examples of such a system are the CPRM (Copy Protection for Recordable Media) system for DVD-RW, DVD-R, DVD-RAM and the CPPM (Copy Protection for Prerecorded Media) system for prerecorded media (see http://www.4centity.org).

Key blocks (KBs) are essentially tables of cryptographic information which are distributed on empty R and RW media with the purpose of rendering revoked players and recorders inoperable. To that end all players and recorders supporting the content protection system are endowed with device specific sets of device keys at manufacturing time (so every device has a unique set), and these devices process the KB with their device keys with the purpose of obtaining a common root key Kᵣₒₒₜ (also sometimes referred to as the Media key Kₘ). The KB is prepared in such a way that all regular devices will indeed calculate the same root key, but all the revoked devices (taken out of the system) will obtain some other value. Since the copy protection system standard of which the KB is part mandates that the content is subsequently encrypted (recorder) or decrypted (player) with the root key, this renders the revoked devices useless with these media.

A common problem in the design of these protection systems is to arrange for the storage of a the KB on the blank media. Key blocks can be quite large (100's of kilobytes up to several megabytes). Storage of the KB brings about several issues:
because of its potential size, the KB is hard to hide. Hiding is important because legacy recorders/players which do not support the copy protection system employing the KB can have problems with non hidden KBs: a legacy device might be confused by the presence of KB data where it expects no data or other data; a legacy device might accidentally erase or overwrite the KB, which makes the media useless for subsequent protected recordings which require such KB;
writing KBs on media implies an extra production steps for the media manufacturer: e.g. prewriting requires extra recorders, and pre-embossing necessitates additional complicated etching steps. Given that the vast majority of content is still unprotected there will be little incentive for the manufacturer to add a KB to the blank media;
storage of the KB should preferably not require new detection circuitry which is not already present in current recorders/players, i.e. the KB should be readable with a simple firmware change. An unfavorable example is e.g. the storage area of the KB on BD-RE requires a special kind of wobble detector which is used for no other purpose.

Some examples from the state of the art such as CPRM use KB storage methods which suffer from these problems.

It is an object of the present invention to provide a record carrier with content protection information stored on it, which can be used with legacy devices without causing confusion, which can substantially be produced without extra production steps compared to the common production of record carriers and which can be easily read by common devices and to provide methods and devices for protecting content stored on a record carrier and for reading out protected content.

In order to achieve said object, a record carrier according to the invention is characterized in that content protection information for protection of said content is stored in said side channel in said data zone.

The invention is based on the idea, that there is currently unused storage space in side channels reserved for future extensions and that this space can be used for storing content protection information. Many types of blank media are already endowed with a relatively low data rate channel to store information relevant for making the recording. E.g. on DVD+R\W media the ADIP (Address in Pregroove) is a high frequency phase modulated wobble which contains address information and (in the lead-in zone only) parameters to aid the physical recording process for this particular media (laser power, write strategy, disc manufacturer etc.), Similarly BD-RE and BD-R have a modulated pregroove. DVD-R and DVD-RW discs have LPP (Land PrePits), sleeper like indentations carrying this kind of information, and finally DVD-RAM has preembossed lead-in zone and sector headers with the same purpose.

These low data rate channels for storage of address information and disc specific parameters usually have space reserved for future extensions. According to the present invention, this space is used for storing the content protection information, e.g. the KB.

Since the media manufacturer has to create this side channel anyway, there is hardly any cost up (other than for a formatter to provide the right KB data to the side channel). More specifically it is proposed to put the content protection information, e.g. the KB, in the side channel in the data zone (the data zone is the part of the disc which is available for the user to store information; the lead-in and lead-out zones are only available to the recorder and player for administrative purposes). The advantage of storing KBs in the data zone is that a recorder/player usually only needs information from the side channel in the lead-in (for calibrating the laser etc.), so:
the KB data would not be getting in the way of other future extensions of the standard (e.g. double layer DVD+R) which need some space in the side channel in the lead-in;
legacy recorders don't even read the reserved space in the side channel in the data area, so no confusion occurs;
legacy recorders cannot accidentally erase/overwrite the side channel since it is a ROM like feature on an R/RW disc.

In one embodiment of a record carrier according to the invention said record carrier is a DVD+R disc or a DVD+RW disc and said side channel is an ADIP side channel, i.e. the ADIP in the data area is preferably used as a location to store key blocks necessary for a content protection system.

In another embodiment of a record carrier according to the invention said record carrier is a DVD-R disc or a DVD-RW disc and said side channel is a LPP side channel, i.e. the KBs are stored in the LPPs.

The solution described above works well for relatively small KBs. However over the lifetime of a copy protection system it is possible that the KB can grow quite large. A low data rate side channel like ADIP will not be convenient in that case because it may have limited space or take too long to retrieve before a recording can start. E.g. on DVD+R\W ADIP can store approx. 500 Kbytes, but uses up the ADIP of the entire disc to store such KB and therefore takes ˜1 hour to read at common writing speeds. As an alternative, in case of large KBs, the invention relates to the fact that on DVD+RW and DVD+R the media manufacturer prewrite the KB as regular EFMP data in the so called Initial Zone. Therefore, a preferred embodiment of a record carrier according to the invention is characterized in that said content protection information comprises a reference, in particular a pointer, to a storage location of a key block stored in said initial zone.

It should be noted that other locations in the lead-in currently unused can be selected to store the KB (such as some sectors of the Control Data Zone). A list of such other less preferred candidates is: Guard Zones 1,2 and 3, Reserved Zones 1,2 and 3, Buffer Zones 1,2 and 3, and Guards; and DVD+RW only: Reserved Zone 4. For DVD-R\W again the Initial Zone is preferred but also the following candidates exist: Initial Zone, Buffer Zone 1 and 2.

It should be noted that the Initial Zone as a storage location is also not completely free of problems: this zone is located at the very inner radius of the disc where writable material is present. Due to the current disc manufacturing process the quality of the material at the very inner and outer edges of the disc is not as reliable as away from these edges. So preferably the KB is written as closely as possible towards the end of the Initial Zone, but then the KB's starting location would be KB length dependent, a number not initially known to a recorder. For that reason, according to the method according to the invention, it is proposed to introduce a pointer stored in a safe place on the disc. The pointer indicates the location where exactly the KB starts in the Initial Zone (or other zone). Preferably such pointer is written in the ADIP, because recorders need to read the ADIP anyway. This will give disc manufacturers the flexibility to store the key block where they deem fit.

In a particular embodiment, a value of pointer=0 can be used to indicate that there is no KB present in the Initial Zone, but that the KB in the ADIP must be used.

A further preferred embodiment of a record carrier according to the invention is characterized in that said content protection information comprises a reference, in particular a pointer, to a storage location of a backup of said key block stored in said initial zone. A disc manufacturer may gain a competitive advantage by putting a given KB not only in a slow side channel like ADIP (cheap) but also storing a copy of the KB in the Initial Zone (extra writing step in production), even for relatively short KBs. For the higher price tag such discs will provide faster start up times because recorders have the option to use the KB from the Initial Zone. In addition this provides greater robustness, because if for some reason the KB in ADIP or Initial Zone is not readable, a backup alternative exists. The presence of such additional copies of the KB can be indicated through a pointer as elucidated in the previous section.

A still further embodiment of a record carrier according to the invention is characterized in that said record carrier is a DVD and a copy of said content protection information is stored in Buffer Zone 2. Both slow side channels like ADIP and the initial zone are convenient ways to distribute the KB to recorders. However players generally have more limited functionality which doesn't require them to be equipped to read from recorder specific side channels or maintenance zones like the Initial Zone. In other words, although recorders will be able to read and process the KB in these 2 locations, players cannot without extra electronics (to access e.g. ADIP) or mechanically redesigned OPUs (Optical Pick up Unit, the sledge containing the laser etc. which in players will bump into the disc motor before reaching the Initial Zone).

To avoid this problem it is proposed that recorders copy (if this hasn't already been done) the KB from either ADIP or Initial Zone (wherever the KB resides) to Buffer Zone 2 as normal EFMP data. All players can access Buffer Zone 2, which is not used for other purposes right now. Additionally Buffer Zone 2 has the advantage that legacy recorders will not (accidentally) overwrite it if data has already been written to it, nor will such recorders be confused by data already written there. Note that the one exception is the disc format command which will erase most of the disc, but not the Initial Zone and obviously not the ADIP; in such case the next recorder which writes to the disc can restore the KB to Buffer Zone 2).

Methods and devices for protecting content on a record carrier and for reading out protected content are defined in claims 9 to 12. A computer program comprising computer program code means for causing a computer to perform the steps of the method as claimed in claim 9 or 12 when said computer program is run on a computer is claimed in claim 13.

In the following, embodiments of a record carrier and devices for protecting content on a record carrier and for reading out protected content according to the invention are further described in detail with reference to the figures, in which:

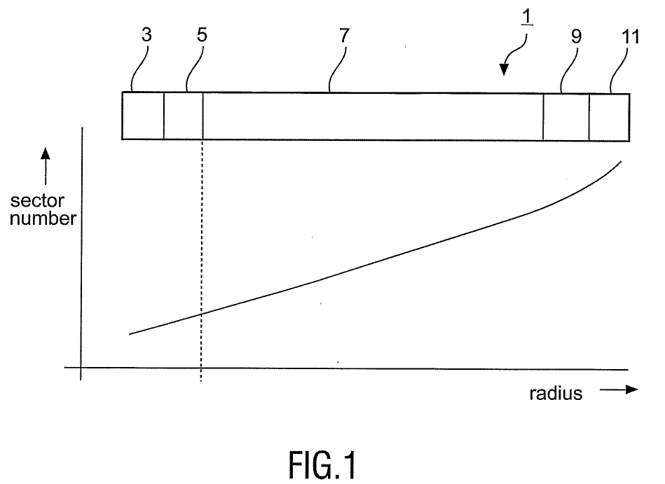

FIG. 1 schematically illustrates a lay-out of a typical DVD+R or DVD+RW record carrier,

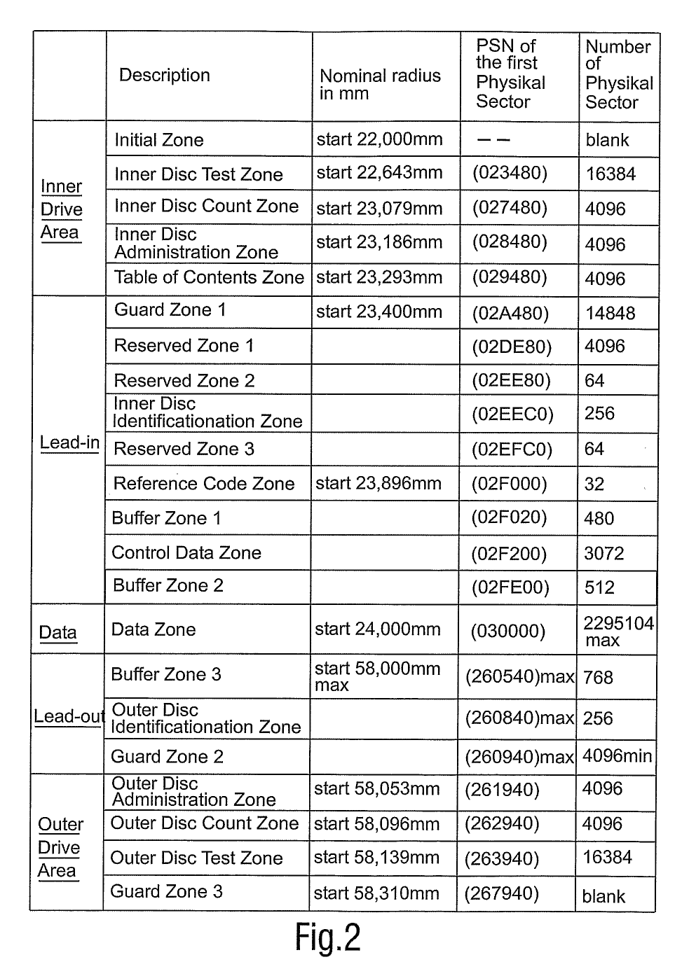

FIG. 2 shows a lay-out of a DVD+R record carrier,

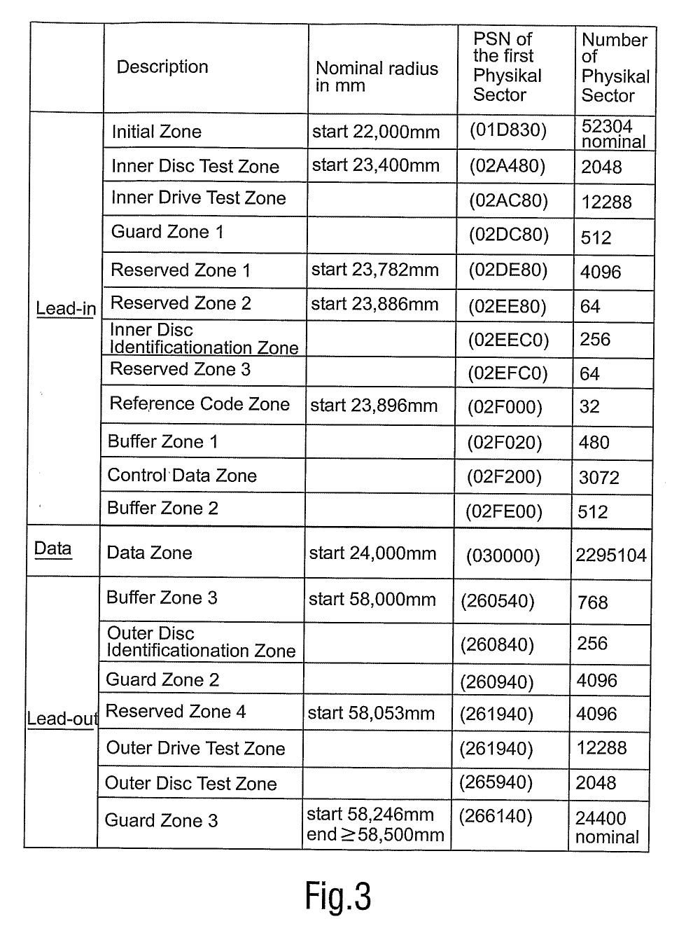

FIG. 3 shows a lay-out of a DVD+RW record carrier,

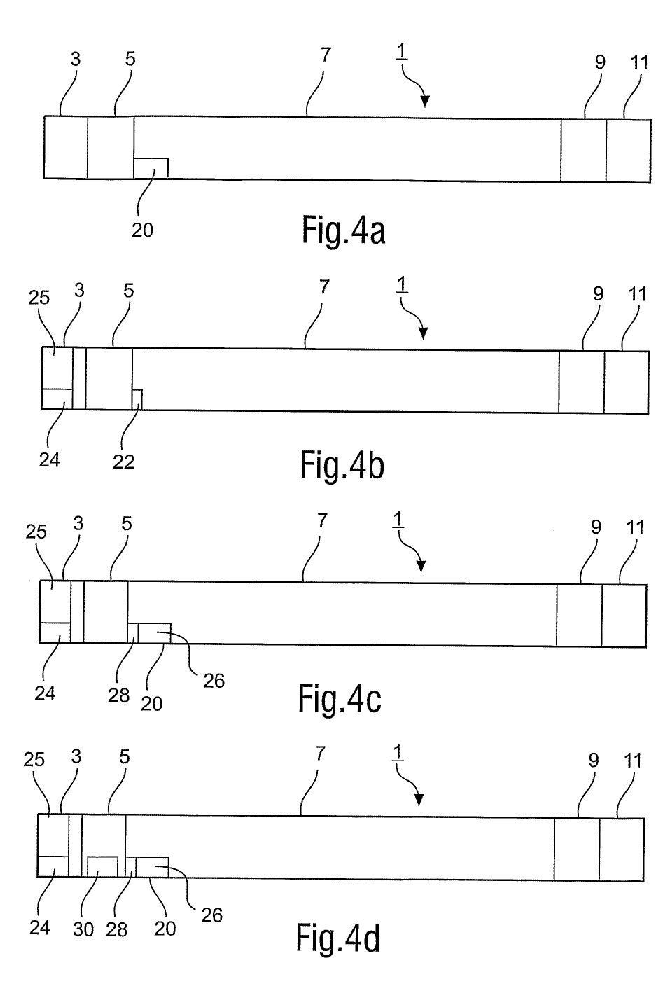

FIG. 4a to 4d show preferred embodiments of a record carrier according to the invention.

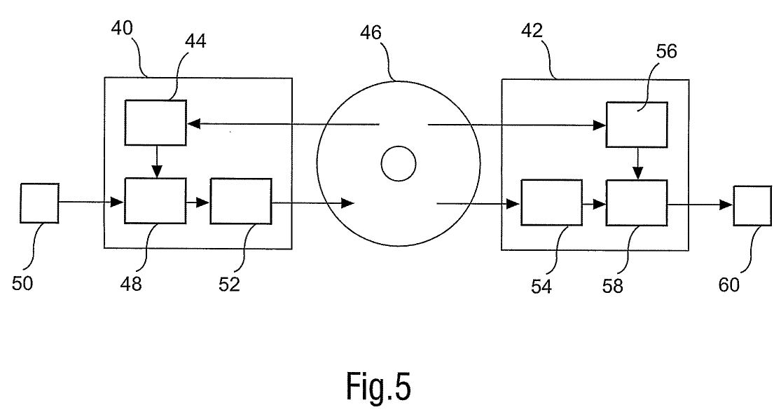

FIG. 5 shows a block diagram of a content protecting device and a read-out device.

FIG. 1 schematically illustrates a lay-out of a typical DVD+R or DVD+RW record carrier. The information zone 1 of the record carrier (not shown) comprises an inner drive area 3, a lead-in zone 5, a data zone 7, a lead-out zone 9, and an outer drive area 11 in this order from the inner to the outer regions of the record carrier. The sector number increases with increasing radius. The data zone 7 starts as indicated by the dotted line at physical sector number $030000.

FIG. 2 shows a lay-out of a DVD+R record carrier comprising different zones as shown in FIG. 1. These zones comprise further zones, which are explained in more detail with a description, a nominal radius, a sector number and a number of physical sectors. Zones related to the present invention are the initial zone, buffer zone 2 and the data zone.

FIG. 3 shows a lay-out of a DVD+RW record carrier corresponding to FIG. 2.

FIGS. 4a to 4d show preferred embodiments of a record carrier according to the invention. FIG. 4a shows content protection information 20, i.e. a key block in this case, stored in the data zone 7. It is not illustrated here that the key block 20 is stored in a side channel of the data zone 7. When content protection information is stored in a reserved part of said side channel it will not confuse legacy players or recorders not compliant with the present invention.

FIG. 4b shows an embodiment in which content protection information 22 is stored in the data zone 7. The content protection information 22 comprises a reference, in particular a pointer, to a storage location of a key block 24 in the inner drive area 3, in particular in the initial zone 25. Information stored in the inner drive area 3 can be accessed faster than information in the side channel of the data zone 7. This provides faster start up times.

FIG. 4c shows a preferred embodiment combining the advantages of the embodiments shown in FIGS. 4a and 4b. The content protection information 20 comprises a key block 26 and a reference 28, in particular a pointer, to a copy 24 of said key block 26 stored in the initial zone 25 of the inner drive area 3. This embodiment has a greater robustness compared to those of FIGS. 4a and 4b since there is a key block 26 and a backup copy 24. When one of those cannot be read there is still one left to provide information for a content protection system.

FIG. 4d shows another preferred embodiment with an additional copy 30 of the key block 26 stored in the lead-in zone 5, in particular in the a zone called “buffer zone 2”. The content protection information 20, 24, 26, 28 is not accessible to common play-back devices. To provide these play-back devices with the content protection information without the need of additional equipment a copy 30 is stored in an accessible area.

FIG. 5 shows a block diagram of a content protecting device 40 and protected content read-out device 42. The content protecting device 40 comprises a means 44 for reading out content protection information from a record carrier 46, a means 48 or encrypting or protecting content provided by a source 50 using said content protection information, and a means 52 for writing said encrypted or protected content on said record carrier 46. The protected content read-out device 42 comprises a means 54 for reading out said protected content from said record carrier 46, a means 56 for reading out said content protection information from said record carrier 46, and a means 58 for decrypting said protected content using said content protection information and outputting unprotected or decrypted content to a receiver 60.

The described method, record carrier, apparatus and system according to the invention have several advantages:
legacy recorders not compatible with such copy protection system can still use the media, so only a single type of media needs to be sold to consumers for all applications;
the storage methods of the key block are arranged such that after use of the media in legacy recorders, the key block is still readable in devices compatible with the copy protection system;
legacy recorders/players can be modified through a simple firmware upgrade to be able to read the key block stored using the disclosed methods;
the disclosed storage methods of the key block are such that they introduce minimal or no additional cost up in the media manufacturing process.

The invention can be summarized as follows: The invention relates to a method to distribute a key block through blank recordable media for use in copy protection systems based on such a key block, a record carrier comprising such a key block, an apparatus for reading out such a record carrier and a copy protection system employing such a KB. Different embodiments of the method according to the invention for storing this key block on a record carrier are given, e.g. relating to the introduction of a pointer stored in a safe place on the record carrier, the pointer indicating the position where the KB starts or to the copying of the key block to another zone present in the lead-in of the record carrier.

It is to be noted that content protection information referred to in this application comprises information for a content protection system such as a key block but also information such as a reference, in particular a pointer, to a storage location where a key block is stored. Further, the term “key block” is not to be understood as relating only to an actual key block but also to content protection information in general.

1. A record carrier having a data zone (7) and an initial zone (25) and comprising a main channel storing content and a side channel storing address information and data relevant for making recordings, characterized in that content protection information (20, 22, 26, 28) for protection of said content is stored in said side channel in said data zone.

2. A record carrier as claimed in claim 1, characterized in that said content protection information (20) comprises a key block (20, 26).

3. A record carrier as claimed in claim 1, characterized in that said content protection information (22) comprises a reference (22), in particular a pointer, to a storage location of a key block (24) stored in said initial zone (25).

4. A record carrier as claimed in claim 2, characterized in that said content protection information (20) comprises a reference (28), in particular a pointer, to a storage location of a backup (24) of said key block (26) stored in said initial zone (25).

5. A record carrier as claimed in claim 1, characterized in that said content protection information is stored as a part of said address information.

6. A record carrier as claimed in claim 1, characterized in that said record carrier is a DVD+R disc or a DVD+RW disc and said side channel is an ADIP side channel.

7. A record carrier as claimed in claim 1, characterized in that said record carrier is a DVD-R disc or a DVD-RW disc and said side channel is a LPP side channel.

8. A record carrier as claimed in claim 1, characterized in that said record carrier is a DVD and a copy of said content protection information is stored in Buffer Zone 2.

9. A method for protecting content stored on a record carrier, said record carrier having a data zone (7) and an initial zone (25) and comprising a main channel storing content and a side channel storing address information and data relevant for making recordings, characterized in that content protection information (20, 22, 26, 28) for protection of said content is stored in said side channel in said data zone (7) and is used for protecting said content.

10. A device for protecting content stored on a record carrier, said record carrier having a data zone (7) and an initial zone (25) and comprising a main channel storing content and a side channel storing address information and data relevant for making recordings, characterized by means for using content protection information (20, 22, 26, 28) for protection of said content, said content protection information (20, 22, 26, 28) being stored in said side channel in said data zone (7).

11. An apparatus for reading out protected content stored on a record carrier, said record carrier having a data zone (7) and an initial zone (25) and comprising a main channel storing content and a side channel storing address information and data relevant for making recordings, characterized by
means for reading out of said protected content,
means for reading out of content protection information (20, 22, 26, 28) for protection of said content stored in said side channel in said data zone,
means for decrypting said content using said content protection information (20, 22, 26, 28).

12. A method for reading out protected content stored on a record carrier, said record carrier having a data zone (7) and an initial zone (25) and comprising a main channel storing content and a side channel storing address information and data relevant for making recordings, comprising the steps of
reading out of said protected content,
reading out of content protection information (20, 22, 26, 28) for protection of said content stored in said side channel in said data zone,
decrypting said content using said content protection information (20, 22, 26, 28).

13. A computer program comprising computer program code means for causing a computer to perform the steps of the method as claimed in claim 9 when said computer program is run on a computer.
